(19) United States
(12) Patent Application Publication
(10) Pub. No.: US 2011/0022417 A1
(43) Pub. Date: Jan. 27, 2011

(54) INSURANCE QUOTING SYSTEM AND METHOD

(76) Inventor: Nagaraj V. RAO, Flower Mound, TX (US)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(21) Appl. No.: 12/509,205

(22) Filed: Jul. 24, 2009

(51) Int. Cl. G06Q 40/00

(52) U.S. Cl. 705/4

(57) ABSTRACT

An insurance quoting system comprises a quotation module executable by a processor where the quotation module is configured to receive from a user a request for a rate quote for an insurance product via a website associated with a first broker. The quotation module is also configured to determine whether the first broker is authorized to provide the insurance product to the user and, if the first broker is not authorized to provide the insurance product, automatically locate a second broker authorized to provide the insurance product to the user.

### BACKGROUND

Consumers looking for insurance products (e.g., automobile insurance, health insurance, life insurance, home insurance, etc.) often turn to the Internet or an insurance broker to obtain an insurance premium estimate (a.k.a., a rate quote). For example, a consumer may use the Internet to connect to the website of an insurance broker via a browser on a network-enabled computer. The consumer then enters one or more desired parameters related to the insurance product (e.g., deductible amount; coverage amount; type of automobile; and the consumer's personal information, such as name, address, phone number, etc.). After the parameters have been entered, different insurance providers formulate an insurance premium estimate or rate quote based on the parameters provided by the consumer. The rate quotes are then provided to the consumer.

### BRIEF DESCRIPTION OF THE DRAWINGS

The accompanying drawings incorporated in and forming a part of the specification illustrate several aspects of the present disclosure and, together with the description, serve to explain the principles of the present disclosure. In the drawings:

FIG. 1 is a schematic diagram illustrating an embodiment of an insurance quoting system;

FIG. 2 is a block diagram illustrating an embodiment of a server in the insurance quoting system of FIG. 1; and

FIGS. 3A and 3B are a flow chart depicting an embodiment of an insurance quoting method.

### DETAILED DESCRIPTION OF THE DRAWINGS

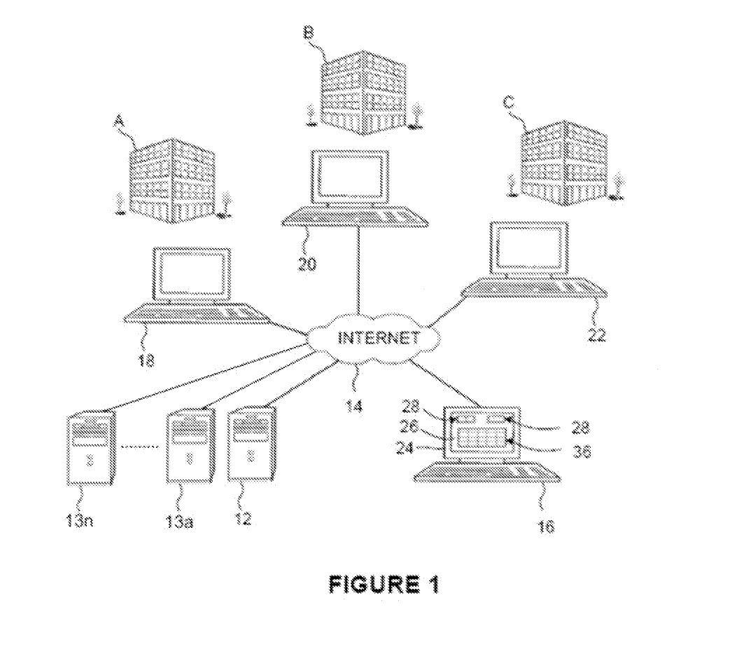

Referring now to FIG. 1, an embodiment of an insurance quoting system 10 for providing insurance premium estimates to a user (e.g., a consumer or potential customer). As will be more fully explained below, system 10 enables the user to obtain insurance premium estimates (a.k.a., rate quotes) from different insurance providers. System 10 also automatically controls and manages the rate quote submission process to ensure that the request for the rate quote is submitted to an insurance provider in association with an insurance broker that is authorized or licensed to provide or sell the insurance product. For example, in some instances, the user may access a website of an insurance broker to obtain a rate quote for an insurance product. System 10 analyzes the information provided by the user and, if the insurance broker is not authorized to sell or provide the insurance product to the user (e.g., the insurance broker may be unlicensed for the particular type of insurance product, unlicensed for the jurisdiction where the user resides or the jurisdiction in which the insurance product applies, not subscribed to the particular service used to obtain or provide the quotes, lack a contractual relationship with one or more insurance providers, limited to selling/providing insurance products in certain states by the subscription service offering the quoting service, not qualified to provide the insurance product based on certain rules or procedures set forth by the quoting subscription service, or other reason), system 10 automatically locates, identifies and provides to the user information pertaining to another insurance broker authorized to provide/sell the insurance product. In some embodiments, system 10 may redirect the user to another website and automatically interface with one or more insurance providers to obtain rate quotes for the desired insurance using the credentials of the authorized insurance broker. A broker as used herein may be any person that sells or otherwise provides an insurance product to a consumer (e.g., independent of whether the seller is representing the interests of the consumer (e.g., broker) or the insurance provider (e.g., agent)).

In the embodiment illustrated in FIG. 1, system 10 comprises servers 12 and 13a-13n operably coupled through a network 14 to a computer 16 of a user, a computer 18 of insurance provider A, a computer 20 of insurance provider B, and a computer 22 of insurance provider C. In the embodiment illustrated in FIG. 1, servers 12 and 13a-13n are web servers. For example, in some embodiments, web servers 13a-13n host websites of insurance brokers that may be accessed by a user or client (e.g., a consumer using computer 16) to obtain a rate quote for various types of insurance products. In some embodiments, server 12 is configured to receive the requests from servers 13a-13n via network 14. In that regard, server 12 may be equipped to accommodate data formatted as Hypertext Markup Language (HTML) and communicated using a standard communication protocol such as, for example, Hypertext Transfer Protocol (HTTP). In some embodiments, server 12 may receive information for a rate quote request from servers 13a-13n by having an embedded inline frame on a page of the insurance broker website such that information input by the user into the website of the insurance broker is received and processed by server 12. Servers 12 and 13a-13n may be equipped for wireless communication, wired communication, or a combination thereof, over network 14. It should be understood that servers 12 and 13a-13n may be other types of computing platforms. Also, while server 12 is depicted in FIG. 1 as receiving requests from a single client computer 16, additional client computers 16 may be present and accommodated by server 12. Multiple servers 12 may also be used.

In FIG. 1, network 14 is the Internet, which is a global system of interconnected computer networks that interchange data by packet switching using the standardized Internet Protocol Suite (TCP/IP). In some embodiments, network 14 may be another suitable network such as, for example, a wide area network (WAN), local area network (LAN), intranet, extranet, etc., or any combination thereof. Network 14 is configured to facilitate wireless communication, wired communication, or a combination thereof, between servers 12 and 13a-13n, computer 16, computer 18, computer 20, and computer 22.

In FIG. 1, computer 16 is illustrated as a desktop personal computer (PC). However, it should be understood that computer 16 may be a variety of other network-enabled computing devices such as, for example, a server, laptop computer, notebook computer, tablet computer, personal digital assistant (PDA), wireless handheld device, cellular phone, and/or thin-client. Computer 16 is equipped for wireless communication, wired communication, or a combination thereof, over network 14.

In addition to other various types of software, computer 16 generally includes an Internet browser installed thereon. The browser of computer 16 is generally capable of displaying on a display 24 of the computer 16 an HTML document. In particular, the browser is capable of displaying an interface screen 26 (e.g., in the form of a graphical user interface (GUI)), which is based on the HTML document generated by server 12.

As shown in FIG. 1, interface screen 26 includes one or more input regions 28 where, for example, user profile information, a type of insurance, and one or more parameter values relating to the type of insurance may be input into computer 16 using a keyboard, mouse, or another input device. Input regions 28 may be configured, for example, as blank data fields, drop-down menus providing potential selections, a series of check boxes permitting the user to “check” a listed selection, or otherwise for receiving user profile information, a type of insurance and parameter values.

As used herein, user profile information may include, for example, the name, contact information, date of birth, and social security number of the user. Also, the type of insurance may include, for example, automobile, homeowners, business, disability, health and life insurance. In addition, parameters comprise one or more conditions generally related to a particular type of insurance. For example, parameters may include, for example, a deductible amount for insurance, a coverage amount for insurance, the state of residence of the user, an indication of whether or not the user is a tobacco user, the medical history of the user, the number of automobile accidents the user has been involved in the recent past, the number of traffic violations the user has had during a preceding time frame, the make, model and year of vehicle of the user, the age of the user, where the home/automobile is located and combinations thereof.

Still referring to FIG. 1, the browser of computer 16 is capable of displaying on display 24 quote data 36. Quote data 36 includes insurance premium estimates from one or more insurance providers (e.g., insurance provider A, insurance provider B, and/or insurance provider C). These insurance premium estimates may be reviewed, compared and considered by the user of computer 16 who may be, for example, contemplating purchasing insurance from one of several different insurance providers based on the provided rate quotes. In some embodiments, the insurance premium estimates of quote data 36 may be conveyed to the consumer without employing the browser. For example, quote data 36 may be incorporated into an electronic mail message, included as an attachment to an electronic mail message, delivered via facsimile, sent as a text message, accessed through a hyperlink, or communicated using another format or method.

In addition to the above, the browser displays a variety of other information on the display 24 of computer 16. Such information may include, but is not limited to, the name and contact information of each insurance provider giving an insurance premium estimate, the input parameters, a button or link permitting the direct purchasing of insurance from a particular insurance provider through the insurance broker, a button permitting the page to be printed, and the contact information of the insurance broker. Further, browser may display errors in input information, the types of insurance products offered through the insurance broker and/or, in response to the information input by the user, that the insurance broker is unable to provide the requested insurance product.

Even though generally not affiliated with one another, for the sake of convenience in the discussion below, each of computer 18, computer 20, and computer 22 in FIG. 1 may be collectively referred to as computers 18, 20 and 22 while their affiliated insurance providers may be collectively referred to as respective insurance providers A, B and C. Each of computers 18, 20 and 22 may be a server, web server, some type of personal computer (PC), or other computer device equipped with appropriate hardware and/or software for communication with server 12 through network 14. Also, while three computers 18, 20 and 22 and three insurance providers A, B and C are illustrated in FIG. 1, more or fewer computers and insurance providers may be accessible to server 12 through network 14.

Each of computers 18, 20 and 22 is equipped with software and/or hardware for generating insurance premium estimates based on a given parameter or set of parameter values. For example, a trial-calculation engine capable of calculating insurance premium estimates may be installed on computers 18, 20 and 22. The particular hardware and/or software on each of computers 18, 20 and 22 may be independently developed by the particular insurance provider A, B and C. In other words, each insurance provider A, B and C may have their own proprietary system, method, or algorithm for computing insurance premium estimates. Computers 18, 20 and 22 are each equipped for wireless communication, wired communication, or a combination thereof, over network 14.

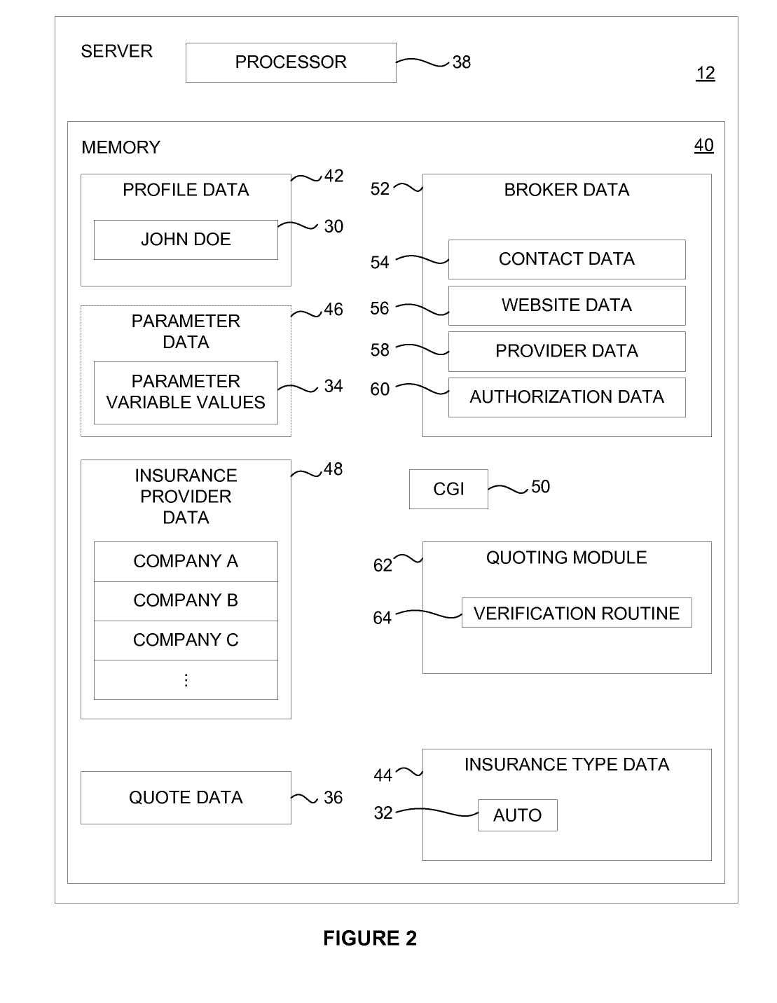

Referring now to FIG. 2, server 12 is illustrated in further detail. As shown, server 12 includes, among other things, a processor 38 and a memory 40. In general, processor 38 processes and/or executes instructions (e.g., software code) and performs logic calculations while memory 40 temporarily or permanently stores information that may be retrieved therefrom. In FIG. 2, memory 40 includes user profile data 42, insurance type data 44, and parameter data 46.

User profile data 42 comprises information associated with a particular user and/or customer seeking insurance rate quote(s). For example, in FIG. 2 user profile data 42 contains user profile data 30 for consumer John Doe. Insurance type data 44 comprises information associated with a desired type of insurance for which a rate quote is desired. For example, in FIG. 2, insurance type data 44 comprises information associated with an auto type 32 of insurance; however, it should be understood that different types of insurance information may be included/represented. Parameter data 46 comprises information associated with different parameters associated with a particular type of insurance for which a rate quote is desired. For example, in FIG. 2, for an auto type 32 of insurance, parameter data 46 comprises different parameter variable values 34 corresponding to auto insurance such as, but not limited to, a deductible amount, a coverage amount, the type of vehicle, the address (e.g., street/city/zip code) of the user or where the vehicle will be located, etc. Information included in user profile data 42, insurance type data 44 and/or parameter data 46 may be received from or selected by a consumer or using computer 16. For example, information associated with profile data 42 may be input by a user using computer 16 and stored by server 12 as profile data 42. Further, a particular type of insurance may be selected by a user and, based on the selection, different parameter options associated with the selected type of insurance may be provided to the user for input/selection. The type of insurance and selection of parameter values are stored by server 12 as insurance type data 44 and parameter data 46. It should be understood various types of information associated with the type of insurance and parameter values for a particular type of insurance may be pre-stored in memory 40 and presented to the user through one or more input screens or data entry interfaces.

Memory 40 also includes insurance provider data 48. Insurance provider data 48 comprises information associated with different providers of insurance offerings (e.g., Companies A, B and C). The information stored as insurance provider data 48 may be predefined and stored in memory 40 (e.g., indicating that particular insurance providers offer particular insurance types, the particular parameter values available through particular insurance providers (such as coverage limits), etc.). It should be understood that insurance provider data 48 may be obtained by server 12 communicating with computers 18, 20 and 22 via network 14 to inquire whether insurance providers (e.g., insurance providers A, B and C) offer a particular type of insurance. In some embodiments, polling of insurance providers may be made to determine the different types of insurance offered by different providers. Information associated with different insurance providers may also be automatically updated in response to updates automatically received from computers 18, 20 and 22 (e.g., without a prompt or request from server 12). In some embodiments, information may be collected from insurance providers according to a predetermined schedule to periodically update information stored in memory 40.

Because of an interface and/or data transferred between server 12, computer 18, computer 20, and computer 22, memory 40 may also include a common gateway interface (CGI) 50. CGI 50 has the ability to receive and process non-standardized data from multiple sources and to output standardized data. In particular, CGI 50 of server 12 may be configured to output a document or data, such as parameter data 46 and profile data 42, in an HTML, XML or any other type of format to facilitate communications with computers 18, 20 and 22, receive information such as rate quotes from computers 18, 20 and 22, and transfer such information to quotation module 62.

In the embodiment illustrated in FIG. 2, memory 40 also comprises broker data 52 comprising information associated with different brokers that provide and/or otherwise make available to consumers different types of insurance products in association with different insurance providers. For example, in the embodiment illustrated in FIG. 2, broker data 52 comprises contact data 54, website data 56, provider data 58, and authorization data 60. Broker data 52 may comprise contact information for different brokers (e.g., name, address, telephone number, etc.) that provide and/or otherwise make available to consumers different types of insurance products in association with different insurance providers. Website data 56 may comprise information related to the uniform resource locator (URL) or website address corresponding to a particular broker. Provider data 58 may comprise relational information correlating each broker to the insurance providers he/she is associated with (e.g., each broker may be registered with and/or otherwise contractually partnered with particular insurance providers for different types of insurance). Authorization data 60 may comprise information indicating the types of insurance products that a particular broker is authorized to sell or provide and/or the geographic jurisdictions where a particular broker is licensed to sell/provide different insurance products.

Memory 40 also has stored therein quotation module 62. Quotation module 62 functions to interface with computers 18, 20 and/or 22 and obtain insurance premium estimates/quotes from insurance companies A, B and/or C. In some embodiments, quotation module 62 is software (e.g., a set of instructions and/or an algorithm) that, when executed by processor 38, generates and/or otherwise provides interface screen 26, receives and stores parameter data 46, receives and stores profile data 42, and interfaces with one or more insurance providers to obtain rate quotes from the insurance providers. In some embodiments, quotation module 62 is some combination of software, hardware, and/or firmware. In some embodiments, quotation module 62 comprises a verification routine 64 that is executable to identify the website the user has accessed and/or otherwise identify the broker the user has selected to obtain a rate quote, verify that the selected broker is authorized to sell/provide the desired insurance product and, if not, automatically locate, identify and display an alternate broker that is authorized to sell/provide the desired insurance product to the consumer. In some embodiments, after the identification of an alternate broker that is authorized to sell the desired insurance product, quotation module 62 automatically interfaces with one or more insurance providers using the alternate broker's identification credentials and obtains rate quotes for the user.

Thus, in operation, a user accesses a website of an broker (e.g., by using a web browser of computer 16 and entering an URL corresponding to a desired broker). The selected website of the broker hosted by one of servers 13a-13n displays information corresponding to the broker (e.g., in the form of one or more hypertext markup language (HTML) pages of the broker's website). The corresponding server 13a-13n also interfaces with server 12 to display interface screen 26 for receiving various types of information for the desired rate quote (e.g., profile data 42, parameter data 46, insurance type data 44, etc.).

Quotation module 62 receives information input by the user via interface screen 26 and evaluates whether the selected broker is authorized to sell/provide the desired insurance product. Quotation module 62 (e.g., via verification routine 64) may identify the selected broker using a variety of types of methods/information (e.g., by evaluating the URL of the broker's website (e.g., accessing website data 56), by evaluating header information embedded in one or more data packets communicated between server 13a-13n and server 12, etc.). Based on broker data 52 corresponding to the selected broker and one or more types of information input by the user, quotation module 62 determines whether the selected broker is authorized to sell/provide the desired insurance product. For example, if the user desires auto insurance, interface screen 26 may prompt the user for a zip code of the user and/or otherwise extract the zip code of the user from input profile data 42. Quotation module 62 accesses broker data 52 corresponding to the selected broker (e.g., authorization data 60) to determine whether the selected broker is authorized to sell auto insurance and/or authorized to sell insurance in the indicated geographic region (e.g., the state indicated by the user's zip code). If the selected broker is authorized to provide the desired insurance product, quotation module 62 identifies the insurance providers associated with the selected broker (e.g., via provider data 58 and/or insurance provider data 48), formulates and/or otherwise generates a request for a rate quote, and submits and/or otherwise electronically communicates the rate quote request to one or more insurance providers. Quotation module 62 receives the rate quote information from the respective insurance providers and stores the rate quote information in memory 40 as quote data 36.

If the selected broker is not authorized to provide the desired insurance product, quotation module 62 automatically searches for, identifies and displays to the user contact information for at least one alternate broker that is authorized to provide the desired insurance product. For example, in some embodiments, quotation module 62 accesses broker data 52 and performs a search of contact data 54 for other brokers located in and/or servicing the geographic area indicated by the user's address and/or zip code. For example, in some embodiments, quotation module 62 searches for brokers within some predetermined distance from the user's address/zip code (e.g., within a five mile radius). If none are found within a first search distance, the search distance may be incrementally increased until at least one broker is located. In some embodiments, if more than one broker is located, quotation module 62 randomly selects one of the located brokers and displays the contact information of such broker to the user. However, it should be understood that other criteria may be used to select/identify one or more alternate brokers for obtaining the desired rate quote (e.g., displaying discovered brokers and prompting a selection by the user, automatically selecting one broker based on a number of different criteria (e.g., alternating selections; selecting based on previous successful/unsuccessful product sales; selecting based on a rating of brokers based on consumer responses or other rating methods; selecting based on a particular service level subscribed to by a particular broker with a service offering the rate quotes; or selecting based on a consumer preference such as product specialty, language ability/fluency, etc.)).

In some embodiments, quotation module 62 automatically submits a rate quote request to one or more insurance providers using the credentials/identification information of the alternate broker independent of user intervention. For example, in some embodiments, in response to determining that the broker selected by the user is not authorized to obtain for the user the desired insurance product, quotation module 62 automatically accesses broker data 52 to locate an alternate broker, identify the insurance providers that the alternate broker is associated with, and automatically generate/submit a rate quote request to the identified insurance providers. In some embodiments, quotation module 62 may automatically redirect the user from the initial broker's website to another website (e.g., a website hosted by server 12, a website corresponding to the alternate broker, etc.).

In the embodiment illustrated in FIG. 2, quotation module 62, memory 40, and processor 38 reside on server 12. However, in some embodiments, quotation module 62, memory 40, and/or processor 38 may be incorporated into another device and/or remotely located relative to server 12 and/or one another. In some embodiments, quotation module 62 is stored on a tangible, computer-readable medium such as, for example, a compact disk (CD), a digital versatile disk (DVD), which is sometimes referred to as a digital video disk, a flash drive, and the like. Further, it should be understood that quotation module 62, and the information used by quotation module 62 (e.g., broker 52, parameter data 46, insurance provider data 48, profile data 42, etc.) may be located remote from server 12 and/or processor 38.

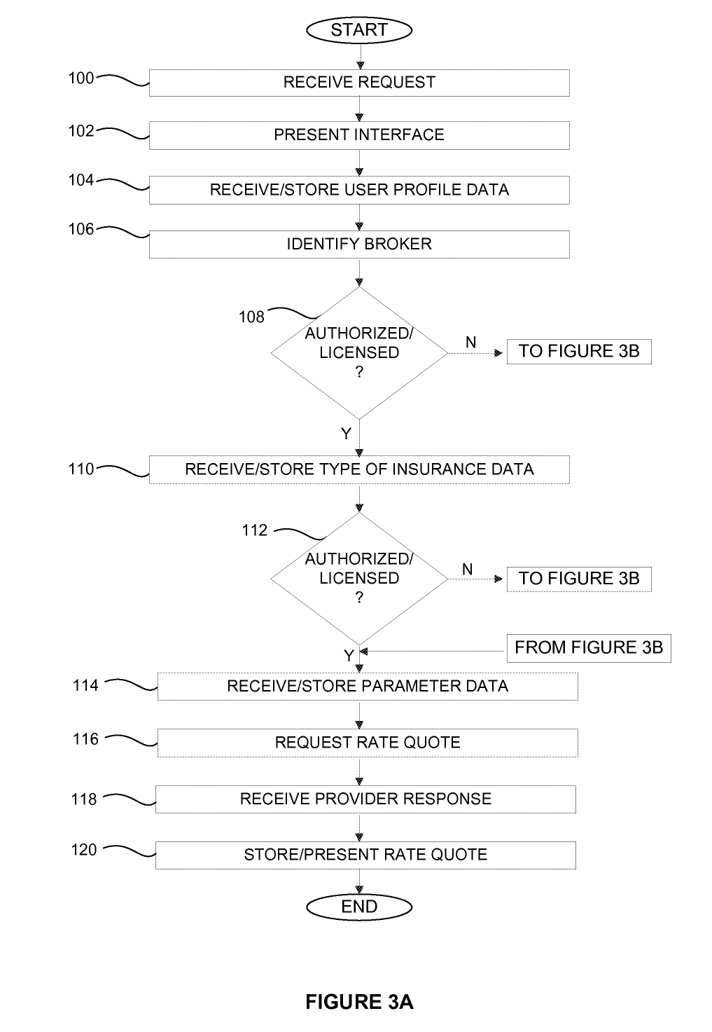

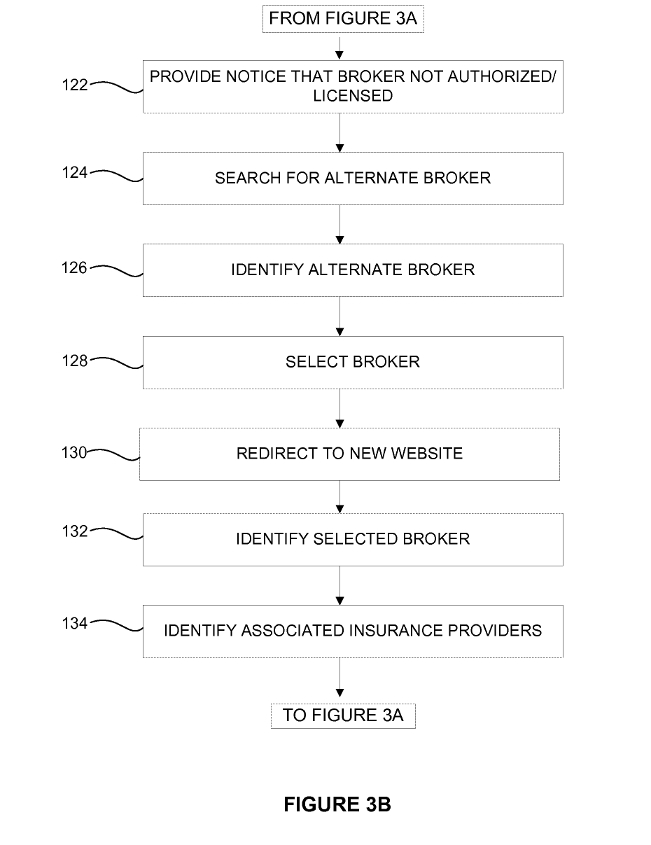

FIGS. 3A and 3B are a flow diagram illustrating an embodiment of a method for providing insurance premium estimates from insurance providers. At block 100, server 12 receives a service request initiated by the user via the browser on computer 16. It should be understood that in some embodiments, the service request may be received by server 12 via a website hosted by one of servers 13a-13n. For example, the service connection request received by server 12 may be initiated by the user inputting into the browser on computer 16 the uniform resource locator (URL) of the website of a desired insurance broker and/or by performing some activity using the website of the broker (e.g., selecting an icon to request a quote).

At block 102, quotation module 62 is executed by processor 38 of server 12 to present the interface screen 26 to the user on display 24 of computer 16. With a keyboard, mouse, or another suitable input device, the user inputs, through input regions 28 of interface screen 26, user profile data 42. Thereafter, user profile data 42 is transmitted through network 14 to server 12. At block 104, server 12 receives and stores user profile data in memory 40.

At block 106, quotation module 62 identifies the broker that the user has currently selected to provide a rate quote (e.g., by analyzing the linked-though website, by extracting information communicated between server 13a-13n and server 12, etc.). At decisional block 108, a determination is made by quotation module 62 whether the current broker is authorized to sell/provide the insurance product desired by the user. For example, quotation module 62 may access authorization data 60 corresponding to the selected broker to determine whether the broker is authorized to sell/provide the desired insurance product. Quotation module 62 may evaluate the user's address and/or zip code to determine whether the broker is authorized to sell/provide the desired insurance product within the state of residence of the user. However, it should be understood that other types of information may be used to determine whether the broker is authorized to sell/provide the desired insurance product. If the broker is not authorized to sell/provide the desired insurance product, the method proceeds to block 122. Otherwise, the method proceeds to block 110.

At block 110, quotation module 62 prompts and/or otherwise requests the user to input, through input regions 28 of interface screen 26, an indication of the type of insurance for which a rate quote is desired. Thereafter, the type of insurance associated with the rate quote request is transmitted through network 14 to server 12 and stored as insurance type data 44 in memory 40. At decisional block 112, a determination is made by quotation module 62 whether the current broker is authorized to sell/provide the insurance product desired by the user based on the type of insurance sought by the user. For example, quotation module 62 may access authorization data 60 corresponding to the selected broker to determine whether the broker is authorized to sell/provide the desired type of insurance product. If the broker is not authorized to sell/provide the desired insurance product, the method proceeds to block 122. Otherwise, the method proceeds to block 114.

Quotation module 62 prompts and/or otherwise requests the user to input, through input regions 28 of interface screen 26, one or more parameter values pertaining to the indicated/selected type of insurance at block 114. For example, if the type of insurance selected/indicated is automobile insurance, the user may input a deductible amount, a desired coverage amount, etc. Quotation module 62 may also access insurance provider data 48 to determine and/or otherwise display to the user various parameter options (e.g., coverage or liability limits). Thereafter, the parameter values are transmitted through network 14 and stored by quotation module 62 as parameter data 46 in memory 40. Quotation module 62 generates and/or otherwise formulates a request for a rate quote using the profile data 42 and the parameter data 46 and communicates/transmits the request at block 116 to one or more insurance providers (e.g., communicating with one or more of computers 18, 20 and 22). For example, in some embodiments, quotation module 62 accesses provider data 48 to identify insurance providers offering the particular type of insurance, insurance providers registered with server 12 offering on-line rate quotes, insurance providers offering real-time or near real-time rate quotes, insurance providers associated with a particular broker, and/or another criteria indicating that the request may/should be transmitted to the corresponding insurance provider. In some embodiments, quotation module 62 may enable a user and/or broker to select and/or otherwise identify the insurance providers to receive the request for rate quote. At block 118, quotation module 62 receives a response from the respective insurance providers. At block 120, the rate quote is stored in memory 40 (e.g., as quote data 36) and/or presented to the user (e.g., displayed).

At decisional blocks 108 and/or 112, if the broker selected by the user (e.g., via the website logged onto by the user) is not authorized to sell/provide the desired insurance product, the method proceeds to block 122, where quotation module 62 provides a notice and/or otherwise alerts the user that the broker selected or being used by the consumer to obtain a rate quote is not authorized to provide the insurance product. At block 124, quotation module 62 accesses broker data 52 to locate an alternate broker that is authorized to sell/provide the desired insurance product. At block 126, quotation module 62 identifies one or more alternate brokers. At block 128, quotation module 62 selects an alternate broker (e.g., by random selection or another type of selection criteria). At block 130, quotation module 62 redirects the user away from the initial website corresponding to the broker not authorized to sell/provide the desired insurance product to another website (e.g., a website hosted by server 12 or the website of the alternate broker). At block 132, quotation module 62 identifies and/or otherwise provides notice to the user of the alternate broker. At block 134, quotation module accesses provider data 58 to identify the insurance providers associated with the alternate broker. The method then proceeds to block 114.

In some embodiments, an insurance provider or broker has a website hosted by one of servers 13a-13n, for example. The website may be directed toward and/or otherwise contain information for a particular insurance provider (e.g., the website URL may be for obtaining an insurance quote from a particular insurance provider, the broker may have a distinct website for providing quotes for a particular insurance provider, etc.). In this embodiment, for example, the website may be connected with a particular broker or connected with a particular insurance provider, such as insurance provider A. In operation, the user accesses the website and inputs profile data 42, parameter data 46, insurance type data 44 and/or other information for obtaining a rate quote. Quoting module 62 communicates the information to one or more insurance providers (e.g., insurance providers a, B and C). The rate quote information is received from computers 18, 20 and 22. Quotation module 62 then filters the received quote information and displays the rate quote corresponding to the particular insurance provider (e.g., insurance provider A). Thus, in this embodiment, although rate quotes may be solicited from different insurance providers, if the website through which the request is made is hosted by, sponsored by, or is otherwise associated with a particular insurance provider, the rate quote for only that insurance provider is provided to the consumer.

It should be understood that in the described method, certain functions may be omitted, accomplished in a sequence different from that depicted in FIGS. 3A and 3B, or simultaneously performed. Also, it should be understood that the method depicted in FIGS. 3A and 3B may be altered to encompass any of the other features or aspects as described elsewhere in the specification. Further, embodiments may be implemented in software and can be adapted to run on different platforms and operating systems. In particular, functions implemented by quotation module 62, for example, may be provided as an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium.

What is claimed is:

1. An insurance quoting system, comprising:
a quotation module executable by a processor, the quotation module configured to receive from a user a request for a rate quote for an insurance product via a website associated with a first broker, the quotation module configured to determine whether the first broker is authorized to provide the insurance product to the user and, if the first broker is not authorized to provide the insurance product, automatically locate a second broker authorized to provide the insurance product to the user.

2. The system of claim 1, wherein the quotation module is configured to display to the user contact information associated with the second broker.

3. The system of claim 1, wherein the quotation module is configured to automatically submit the request for the rate quote to at least one insurance provider using credentials of the second broker.

4. The system of claim 1, wherein the quotation module is configured to alert the user that the first broker is not authorized to provide the insurance product.

5. The system of claim 1, wherein the quotation module is configured to redirect the user from the website of the first broker to another website.

6. The system of claim 1, wherein the quotation module is configured to automatically select the second broker from a plurality of brokers authorized to provide the insurance product to the user.

7. The system of claim 1, wherein the quotation module is configured to randomly select the second broker from a plurality of brokers authorized to provide the insurance product to the user.

8. The system of claim 1, wherein the quotation module is configured to locate the second broker based on at least one geographic attribute associated with the user.

9. The system of claim 1, wherein the quotation module is configured to determine whether the first broker is authorized to provide the insurance product based on at least one geographic attribute associated with the user.

10. An insurance quoting method, comprising:
receiving from a user a request for a rate quote for an insurance product via a website associated with a first broker;
determining whether the first broker is authorized to provide the insurance product to the user; and
if the first broker is not authorized to provide the insurance product, automatically locating a second broker authorized to provide the insurance product to the user.

11. The method of claim 10, further comprising automatically submitting the request for the rate quote to at least one insurance provider using credentials of the second broker.

12. The method of claim 10, further comprising alerting the user that the first broker is not authorized to provide the insurance product.

13. The method of claim 10, further comprising redirecting the user from the website of the first broker to another website.

14. The method of claim 10, further comprising automatically selecting the second broker from a plurality of brokers authorized to provide the insurance product to the user.

15. The method of claim 10, further comprising randomly selecting the second broker from a plurality of brokers authorized to provide the insurance product to the user.

16. A computer program product having stored thereon an instruction set to be executed by a processor, the instruction set, when executed by the processor, causes the processor to:
receive from a user a request for a rate quote for an insurance product via a website associated with a first broker;
determine whether the first broker is authorized to provide the insurance product to the user; and
if the first broker is not authorized to provide the insurance product, automatically locate a second broker authorized to provide the insurance product to the user.

17. The computer program product of claim 16, wherein the instruction set, when executed by the processor, causes the processor to automatically submit the request for the rate quote to at least one insurance provider using credentials of the second broker.

18. The computer program product of claim 16, wherein the instruction set, when executed by the processor, causes the processor to alert the user that the first broker is not authorized to provide the insurance product.

19. The computer program product of claim 16, wherein the instruction set, when executed by the processor, causes the processor to redirect the user from the website of the first broker to another website.

20. The computer program product of claim 16, wherein the instruction set, when executed by the processor, causes the processor to automatically select the second broker from a plurality of brokers authorized to provide the insurance product to the user.
